(19) United States
(12) Patent Application Publication
(10) Pub. No.: US 2018/0241614 A1
(43) Pub. Date: Aug. 23, 2018

(54) TIME SLOT DETERMINATION

(71) Applicant: HEWLETT PACKARD ENTERPRISE DEVELOPMENT LP, Houston, TX (US)

(72) Inventors: Venkatesh Raman Ramteke, Bangalore (IN); Thavamaniraja Sakthivel, Bangalore (IN); Ramaprasad Hosaballi, Bangalore (IN)

(21) Appl. No.: 15/888,620

(22) Filed: Feb. 5, 2018

(30) Foreign Application Priority Data
Feb. 17, 2017 (IN) 201741005782

(51) Int. Cl. H04L 12/24; H04L 12/707; H04L 29/08

(52) U.S. Cl. CPC H04L 41/0663; H04L 41/147; H04L 67/16; H04L 45/22

(57) ABSTRACT

In one example in accordance with the present disclosure, a priority is determined for each element in a plurality of elements connected to a network. The plurality of elements may include a source element, a destination element and a first element selected for downtime. A reliability index is determined for each element in the plurality of elements and a plurality of alternate paths between the source element and destination element are determined, each alternate path including a corresponding plurality of elements. For each alternate path in the plurality, a total utilization of the corresponding plurality of elements of the alternate path may be determined for each of a plurality of time slots and a best time slot to be used as a time period for the downtime of the first element may be determined based on the total utilizations.

### BACKGROUND

Downtime management may refer to a process of selecting a period of time to make certain network resources unavailable to users, so that certain downtime tasks may be performed on the network, elements of the network, etc.

### BRIEF DESCRIPTION OF THE DRAWINGS

The following detailed description references the drawings, wherein:

FIG. 1 is a block diagram of an example environment for time slot determination;

FIG. 2 illustrates several graphs depicting time slot utilization;

FIG. 3 is a flowchart of an example method for time slot determination;

FIG. 4 is a flowchart of another example method for time slot determination;

FIG. 5 is a flowchart of an example method for determining new paths;

FIG. 6 is a flowchart of an example method for determining time slots;

FIG. 7 is a block diagram of an example system for time slot determination; and

FIG. 8 is a block diagram of an example system for time slot determination.

### DETAILED DESCRIPTION

Systems and methods for time slot determination described herein may determine an appropriate downtime window or time slot by taking into consideration the priority of application traffic being serviced by each of the network elements. The systems and methods described herein may provide insight into the impact of the downtime operation on network elements and on the overall performance of the network. For example, the systems and methods described herein may provide analysis on how to avoid application performance degrade when a switch is taken offline for downtime. Similarly, the systems and methods described herein may estimate projected load conditions on the network when alternate failover paths are used during maintenance period.

A method for memory time slot determination may comprise determining, by a processor, a priority for each element in a plurality of elements connected to a network, wherein the plurality of elements includes a source element, a destination element and a first element selected for downtime. The method may include determining, by the processor, a reliability index for each element in the plurality of elements and determining, by the processor, a plurality of alternate paths between the source element and destination element, each alternate path including a corresponding plurality of elements. The method may also include determining, by the processor, for each alternate path in the plurality, a total utilization of the corresponding plurality of elements of the alternate path for each of a plurality of time slots and determining, by the processor, based on the total utilizations, a best time slot to be used as a time period for the downtime of the first element.

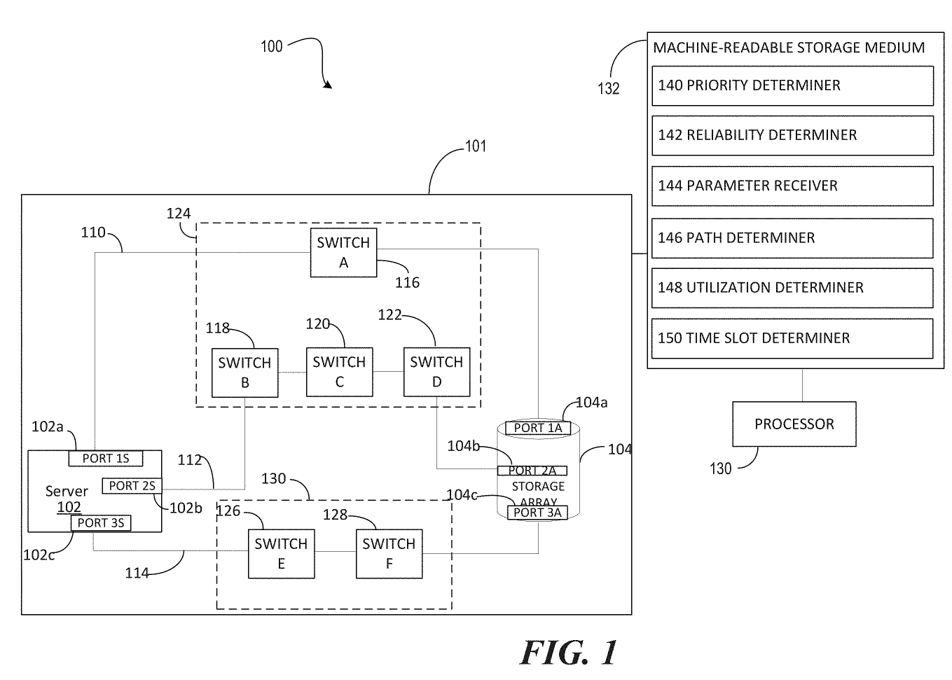

FIG. 1 is a block diagram of an example system 100 for time slot determination. System 100 may include network environment 101. Although network environment 101 is depicted as a Storage Area Network (SAN) environment, other network environments may be used with the discussed techniques. Network environment 101 may include a variety of network elements. As used herein, a “network element” may refer to any hardware or software component in the network environment. Network elements may include, for example, servers, switches, storage arrays, etc. A switch may be a device used for connecting elements on a network. A storage array may be a hardware device that contains one or more disk drives, or other types of storage.

In a SAN environment, a network element may be any component involved in providing storage from a storage array to a host. The host may include a host device, a virtual machine, etc. As user herein, the term “downtime element” refers to an element which is selected to be offline for a maintenance and/or downtime period. Network elements depicted in network environment 101 may include a server 102, a storage array 104, and switches 116, 118, 120, 122, 126, 128. Of course, this is for illustration purposes and other types and number of network elements may be used in addition to and/or instead of the network elements shown in FIG. 1.

Server 102 may be used to execute applications in network environment 101. Server 102 may have port 1S (102a), port 2S (102b) and port 3S (102c) for connecting to other network elements in the network environment 101. For example, server 102 may use ports 102a-102c to connect to other network elements via a wired interface, such as Ethernet, etc. Additionally, different connection paths may be used to connect network elements in network environment 101. One or more of these connection paths may be duplicative, redundant, etc., such that if one connection path is not accessible, a different connection path may be used.

These different connection paths may include a primary path, an existing failover path(s), a new failover path(s), etc. An existing fail over path may refer to an alternate connection path which allows traffic to flow between a source element and a destination element. The existing fail over path may bypass the downtime element. A new failover path is a path which is not currently configured but possible in the network environment 101. If configured, the new failover path would allow traffic to flow between a source element and a destination element. The new fail over path may bypass the downtime element.

In one example, switch A 116 may be taken offline for downtime. In this example, there may be a primary path 110 from a source element (such as server 102) to a destination element (such as storage array 104), an existing fail over path 112 from the source element to the destination element and a new failover path 114 from the source element to the destination element.

Path 110 may connect server 102 (source element) to storage array 104 (destination element). Port 1S (102a) of server 102 may be used to connect server 102 to switch A 116 to port 1A (104a) of storage array 104. Path 110 may be a primary path. Path 112 may also connect server 102 (source element) to storage array 104 (destination element). Port 2S (102b) of server 102 may be used to connect server 102 to switch B 118 to switch C 120 to switch D 122 to port 2A (104b) of storage array 104. Path 112 may be an existing failover path. Switch A 116, Switch B 118, Switch C 120 and switch D 120 may belong to network fabric 124. A network fabric is a network topology using one or more network switches to interconnect network nodes. Port 3S (102c) of server 102 may be used to connect server 102 to switch E 126 to switch F 128 to port 3A (104c) of storage array 104. Path 112 may be an existing failover path.

System 100 may include a processor 130 and a machine-readable storage medium 132 that may be coupled to each other through a communication link (e.g., a bus). Processor 130 may include a single or multiple Central Processing Units (CPU) or another suitable hardware processor(s). In some examples, machine-readable storage medium 132 stores machine readable instructions executed by processor 130 for system 100. Machine-readable storage medium 132 may include any suitable combination of volatile and/or non-volatile memory, such as combinations of Random Access Memory (RAM), Read-Only Memory (ROM), flash memory, and/or other suitable memory.

Machine-readable storage medium 132 stores instructions to be executed by processor 130 including instructions for priority determiner 140, reliability determiner 142, parameter receiver 144, path determiner 146, utilization determiner 148 and best path determiner 150 and/or other components. According to various implementations, system 100 may be implemented in hardware and/or a combination of hardware and programming that configures hardware. Furthermore, in FIG. 1 and other Figures described herein, different numbers of components or entities than depicted may be used.

Processor 102 may execute priority determiner 140 to determine a priority for each element in a plurality of elements connected to a network. The plurality of elements may include a source element, a destination element and a first element selected for downtime. Priority determiner 140 may be used to determine a priority for each application in a plurality of applications served by the network environment 101. The priority may be, for example, a value from 1-10. Of course this is an example and other suitable indexing scales may be used. The priority may be determined by a service level agreement (SLA) defining terms between an operator of network environment 101 and a customer. The priority may be derived from a SLA management tool, provided as input by a user of the system, etc. Priority determiner 140 may determine the priority of each hardware element in the network environment 101 based on the application traffic being served by that element over a period of time. The priority of an element at a first time may be equal to the highest priority of any application being served by the element. In an example where priority values are ranked 1-10, with 10 being the highest priority, if a switch is serving an application of priority 1 and priority 3, priority determiner 140 may determine that the priority of the switch is 3.

Processor 102 may execute reliability determiner 142 to determine a reliability index for each element in the plurality of elements. Reliability determiner 142 may determine the reliability index of elements of the network environment 101 with respect to hourly trend for a selected analysis period. The reliability may be determined by using, for example, a number of severe events, a number of failures, device cyclic redundancy check (CRC) errors, Zero Buffer to Buffer credit at switch ports, I/O response time, etc. The reliability may be indexed from 0-10, with 10 being highest. Of course this is an example and other suitable indexing scales may be used. Each data point may be an aggregated value of an hour. For example, during high load periods on a switch port, Buffer-to-Buffer credit might not be available causing IO flow to queue up for a certain time. Thus, the reliability index for this element during this high load period will be lowered. In some aspects, the reliability index may be determined by combining the number of device errors, the number severe events, etc. and dividing that number by a time duration.

Processor 102 may execute parameter receiver 144 to receive a set of tunable parameters. The set of tunable parameters may include an acceptable reliability index with respect to each application priority and a tolerance in reliability index with respect to each application priority. The tolerance may be an allowed deviation value for the acceptable reliability index. For example, a reliability index may be 100 CRC errors, and the tolerance may be +/− 10 errors. The tunable errors may also include a desired time-slot duration for downtime and a time period for historical analysis of data. These tunable parameters may be received from management tools, SLAs, user input, etc.

Processor 102 may execute path determiner 146 to identify an existing path between the source element and the destination element. The existing path including the downtime element. However, the network traffic associated with the downtime element may be re-routed to alternative paths when the downtime element goes offline during downtime. Accordingly, processor 102 may execute path determiner 146 to determine a plurality of alternate paths between the source element and destination element. Each alternate path may include a corresponding plurality of elements and may not include the downtime element. As described above, alternative paths connecting source and destination elements of downtime elements that are already configured are called existing failover path(s). Processor 102 may execute path determiner 146 to determine a new path that is possible based on the topology of the network but is not currently configured and include the new path in the plurality of alternate paths. Re-configuration of these paths may allow generation of a new path with better reliability between source and destination elements but excluding downtime element. As described above, these paths may be called new failover path(s).

In network environment 101, if switch A 116 is the downtime element, path determiner 146 may identify path 110 as an existing path between the source element (server 102) and the destination element (storage array 104) with the downtime element. However, this path will fail because the downtime element will be taken offline. Accordingly, path determiner 146 may determine an existing fail over path 112. Path determiner 146 may also determine a new fail over path 114. As illustrated in FIG. 1, new failover path 114 contains less elements than existing fail over path 112. Path determiner 146 may also determine a new fail over path that has a higher reliability index (as discussed above in reference to reliability determiner 142).

Processor 102 may execute utilization determiner 148 to determine for each alternate path in the plurality, a total utilization of the corresponding plurality of elements of the alternate path over a time period. The time period may include a plurality of time slots. If, during any time slot belonging to the plurality, the total utilization of the elements in a path exceeds the available resources of the system (such as network environment 101), then the time slot may not be useable as a possible time slot for downtime.

Determining the total utilization may comprise determining a first element and a second element of the corresponding plurality of elements of each alternate path, performing a peak of sum analysis on a first utilization of the first element and a second utilization of the second element with respect to an available bandwidth of the network over a time period. A peak of sum analysis is a type of analysis that takes a plurality of utilizations, each utilization corresponding to an element, and determines a total utilization of the elements over a period of time. The time period may have a plurality of time slots representing different points within the time period. Any time slot may be removed if the total utilization for each element in the alternate path during that time slot exceeds the available bandwidth of the network.

Utilization determiner 148 may determine the total utilization, using, for example a peak of sum (POS) analysis. Utilization determiner 148 may determine an aggregated POS for each path in the plurality of paths for the time period. To determine an aggregated POS for a path utilization determiner 148 may determine the utilization for each element in the path over the time period. The POS analysis may use the utilization trace of the element and perform a peak of sum analysis with respect to an available resource of the network, such as for example, available bandwidth of the network environment 101, over the time period. If the aggregated peak of sum analysis indicates that the total utilization exceeds the available bandwidth for any time slot during that time period, then that time slot may be voided and no longer considered as a possible candidate for a downtime period.

Best path determiner 150 may determine, based on the total utilizations, a best time slot to be used during the downtime of the first element. Best path determiner may take each time slot that has not been voided (i.e. as described above in reference to utilization determiner 148) and sort the time slots based on various criteria. These criteria may include, for example, the type of path for the time slot, the number of elements in the path to reach from source element to the destination element during the time slot, the duration of the time slot and a reliability index of the path and/or elements in the path. Best path determiner 150 may determine a path that best meets these criteria.

In some aspects, the primary criteria for determination may be overhead available, the secondary criteria may be the reliability index and the tertiary criteria may be the number of elements. Of course this is for illustrative purposes and other criteria and other rankings of the importance of the criteria may be used. Best path determiner 150 may determine a path such that the selected path's time slot provides maximum overhead available on POS. Overhead may be determined as the bandwidth or other resource utilization cycles available on the selected path when additional traffic of maintenance element is factored in. In some aspects, the suggested time slot may correspond to a path that needs to be configured and/or reconfigured. If a user does want to re-configure, best path determiner 150 may determine a time-slot that does not use a path that needs to be configured/reconfigured.

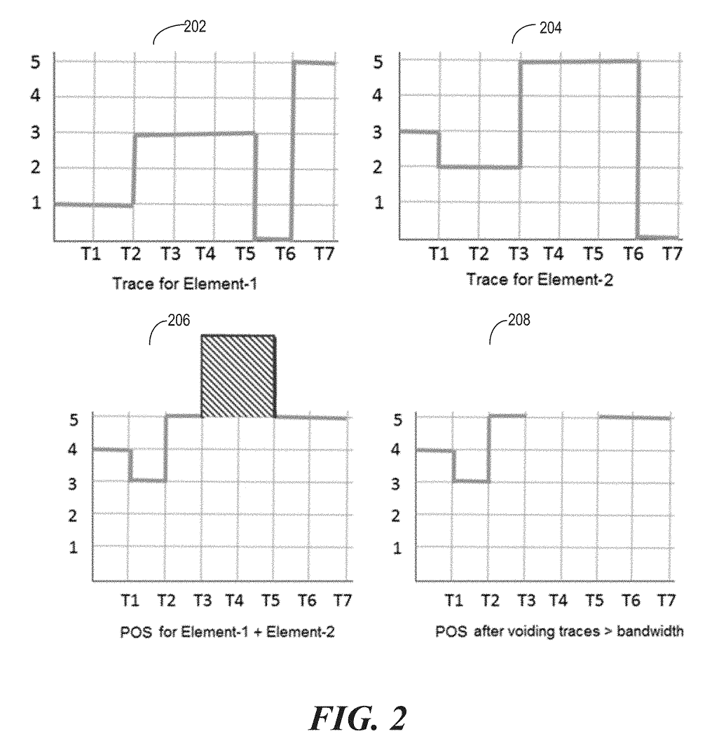

Turning to FIG. 2, graph 202 is an illustration of a utilization trace of a first element with a system having a max bandwidth of 5 GB/s over a time period having seven time slots (T1-T7). As show in graph 202, the first element has a utilization of 1 GB/s from T1-T2, has a utilization of 3 GB/s from T2-T5, a utilization of 0 GB/s from T5-T6 and a utilization of 5 GB/s at T7. Graph 204 illustrates a utilization trace of a second element with a system having a max bandwidth of 5 GB/s. As show in graph 204, element 2 GB/s has a utilization of 3 GB/s at T1, a utilization of 2 GB/s from T1-T3, a utilization of 5 GB/s from T3-T6 and a utilization of 0 GB/s at T7. Turning now to graph 206, an aggregated POS analysis for element 1 and element 2 is illustrated. The aggregated POS analysis combines the individual utilization of the two elements. As seen in graph 206, the maximum bandwidth of the system (5 GB/s) is exceeded from T3-T5. Because the maximum bandwidth of the system is exceeded, the time period is not suitable as a downtime time slot. Accordingly, time slots T3-T5 may no longer be considered as possible downtime time periods. Graph 208 illustrates the remaining candidate downtime time slots with T3-T7 voided out. As used herein, “voided out” refers to removing time slot/path pair as a potential time slot for downtime of the downtime element.

Turning again to FIG. 1, Processor 102 may execute utilization determiner 148 to determine the application priority for each element and/or application for each of the time slots still remaining (i.e. as discussed above in reference to priority determiner 140). Utilization determiner 148 may use the application priority to determine the feasibility of using the time slot. Utilization determiner 148 may also use the reliability-index configured as part of tunable parameter (i.e. as discussed above in reference to parameter receiver 144).

For each of the time-slots obtained, the corresponding paths reliability index may be matched against each element in the path for the time slot. For each time slot, utilization determiner 148 may determine for each element in each alternate path during the time slot, whether the reliability index of the element meets the acceptable reliability index and remove the time slot for the alternate path if any element in the alternate path does not meet the acceptable reliability index during the time slot.

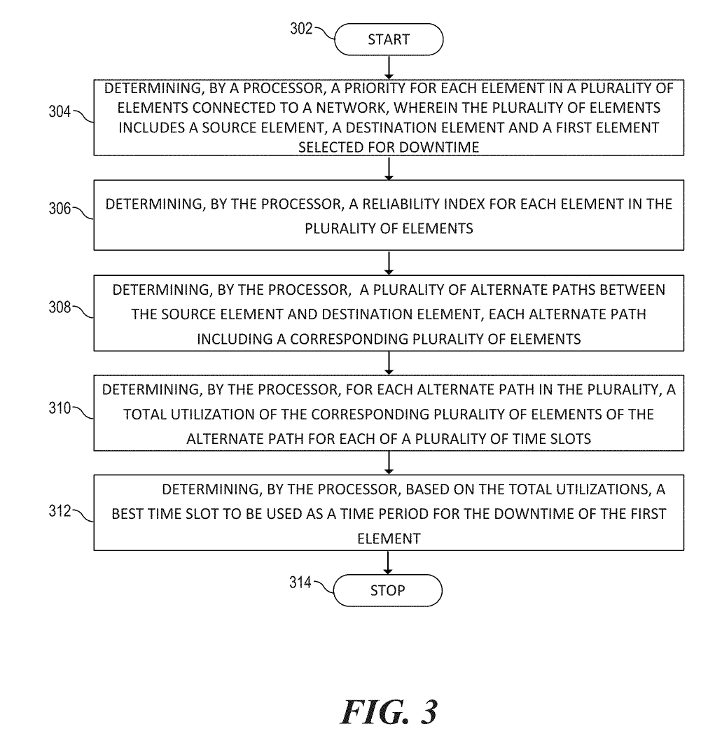

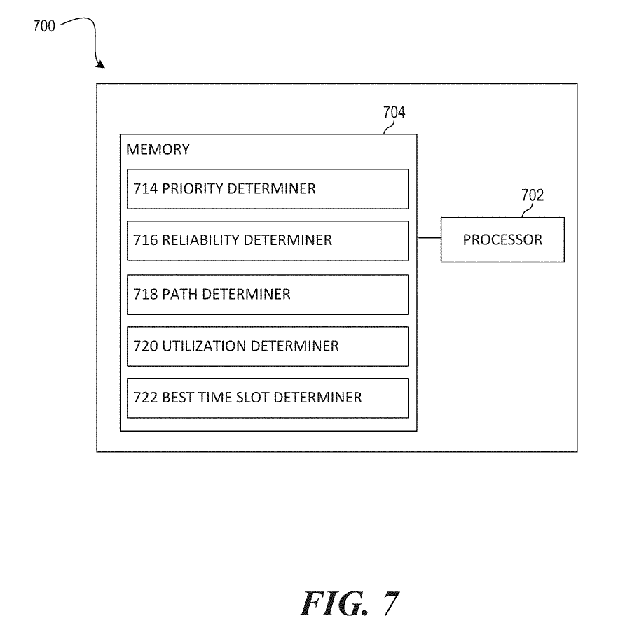

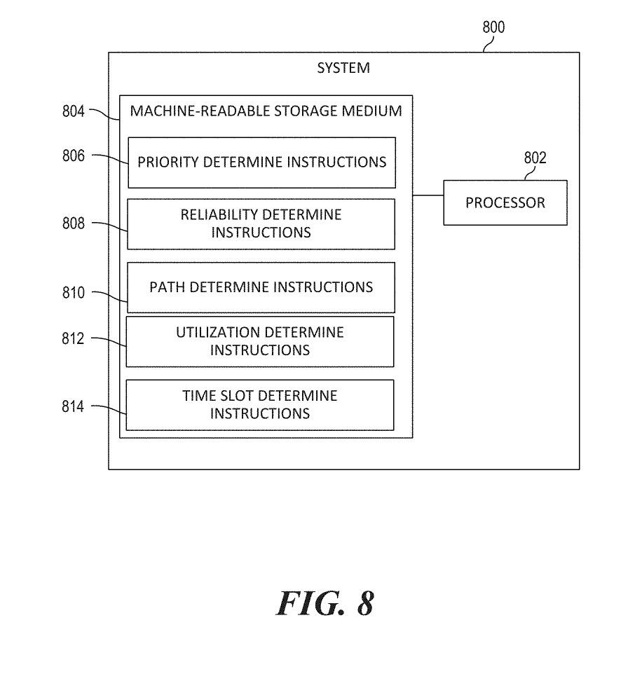

Referring now to FIGS. 3-6 flow diagrams are illustrated in accordance with various examples of the present disclosure. The flow diagrams represent processes that may be utilized in conjunction with various systems and devices as discussed with reference to the preceding figures, such as, for example, system 100 described in reference to FIG. 1, system 700 described in reference to FIG. 7 and/or system 800 described in reference to FIG. 8. While illustrated in a particular order, the flow diagrams are not intended to be so limited. Rather, it is expressly contemplated that various processes may occur in different orders and/or simultaneously with other processes than those illustrated. As such, the sequence of operations described in connection with FIGS. 3-6 are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples.

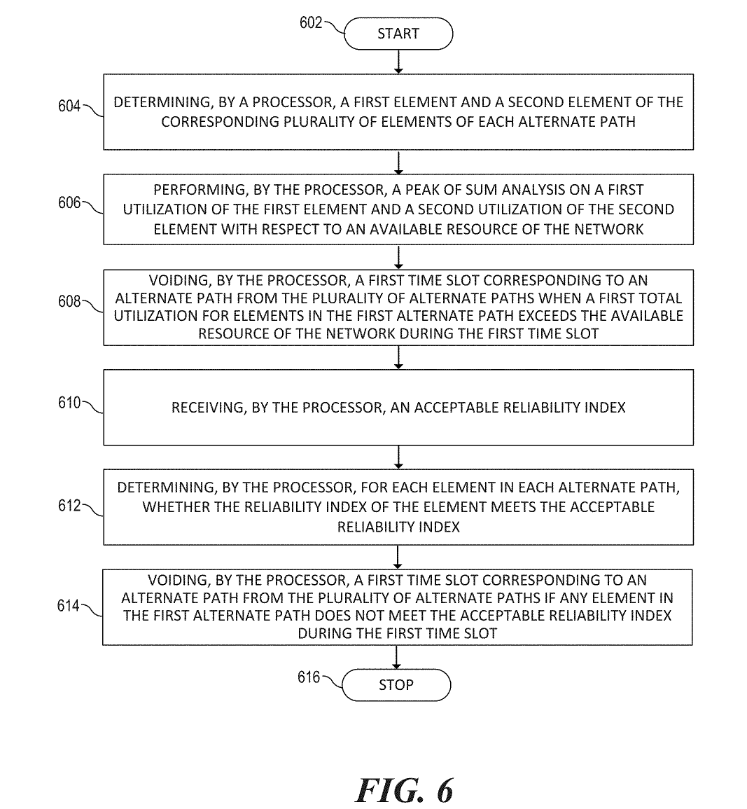

FIG. 3 is a flowchart of an example method 300 for time slot determination. Method 300 may start at block 302 and continue to block 304, where the method 300 may include determining, by a processor, a priority for each element in a plurality of elements connected to a network. The plurality of elements may include a source element, a destination element and a first element selected for downtime. At block 306, the method may include determining, by the processor, a reliability index for each element in the plurality of elements. At block 308 the method may include determining, by the processor, a plurality of alternate paths between the source element and destination element. Each alternate path may include a corresponding plurality of elements. At block 310 the method may include determining, by the processor, for each alternate path in the plurality, a total utilization of the corresponding plurality of elements of the alternate path for each of a plurality of time slots. At block 312 the method may include determining, by the processor, based on the total utilizations, a best time slot to be used as a time period for the downtime of the first element. Further detail for determining the best time slot is explained below in reference to method 600 and FIG. 6. The method may proceed to block 314 where the method may end.

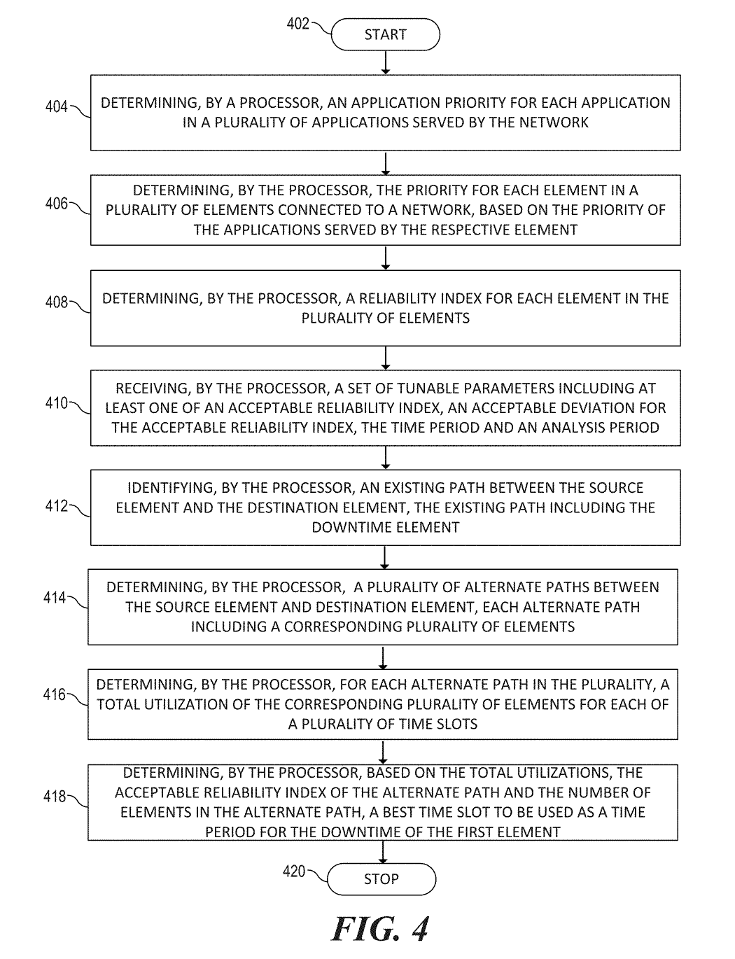

FIG. 4 is a flowchart of an example method 400 for time slot determination in further detail. Method 400 may start at block 402 and continue to block 404, where the method 400 may include determining, by a processor, an application priority for each application in a plurality of applications served by the network. At block 406, the method may include determining, by the processor, the priority for each element in a plurality of elements connected to a network, based on the priority of the applications served by the respective element. For example, the priority of a first element may be equivalent to a highest priority of an application served by the first element. At block 408 the method may include determining, by the processor, a reliability index for each element in the plurality of elements.

At block 410, the method may include receiving, by the processor, a set of tunable parameters including at least one of an acceptable reliability index, an acceptable deviation for the acceptable reliability index, the time period and an analysis period. At block 412 the method may include identifying, by the processor, an existing path between the source element and the destination element, the existing path including the downtime element. At block 414, determining, by the processor, a plurality of alternate paths between the source element and destination element, each alternate path including a corresponding plurality of elements. At block 416, the method may include determining, by the processor, for each alternate path in the plurality, a total utilization of the corresponding plurality of elements for each of a plurality of time slots. At block 418, the method may include determining, by the processor, based on the total utilizations, the acceptable reliability index of the alternate path and the number of elements in the alternate path, a best time slot to be used as a time period for the downtime of the first element. The method may proceed to bock 420, where the method may end.

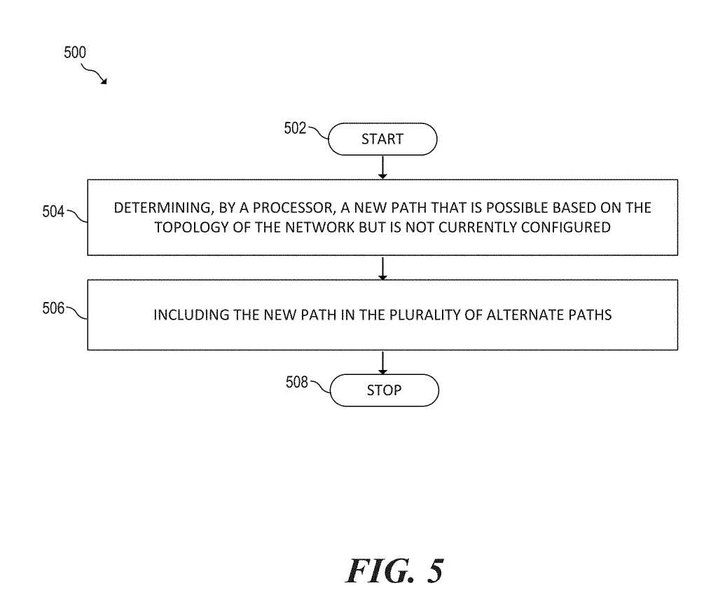

FIG. 5 is a flowchart of an example method 500 for determining new paths. Method 500 may start at block 502 and continue to block 504, where the method may include determining, by a processor, a new path that is possible based on the topology of the network but is not currently configured. At block 506, the method may include including the new path in the plurality of alternate paths. The method may proceed to block 508, where the method may end.

FIG. 6 is a flowchart for an example method 600 for determining time slots. Method 600 may start at block 602 and continue to block 604 where the method may include determining, by a processor, a first element and a second element of the corresponding plurality of elements of each alternate path. At block 606, the method may include performing, by the processor, a peak of sum analysis on a first utilization of the first element and a second utilization of the second element with respect to an available resource of the network. An available resource of the network may include, for example, available bandwidth of the network. At block 608, the method may include voiding, by the processor, a first time slot corresponding to an alternate path from the plurality of alternate paths when a first total utilization for elements in the first alternate path exceeds the available resource of the network during the first time slot.

At block 610, the method may include receiving, by the processor, an acceptable reliability index and at block 612 the method may include determining, by the processor, for each element in each alternate path, whether the reliability index of the element meets the acceptable reliability index. At block 614 the method may include voiding, by the processor, a first time slot corresponding to an alternate path from the plurality of alternate paths if any element in the first alternate path does not meet the acceptable reliability index during the first time slot. The method may proceed to block 616, where the method may end.

FIG. 7 is a block diagram of an example system 700 for time slot determination. System 700 may include a processor 702 and a memory 704 that may be coupled to each other through a communication link (e.g., a bus). Processor 702 may include one or multiple Central Processing Units (CPU) or another suitable hardware processors. In some examples, memory 704 stores machine readable instructions executed by processor 702 for system 700. Memory 704 may include any volatile memory, non-volatile memory, or any suitable combination of volatile and non-volatile memory. Memory 704 may comprise, for example, may be, for example, Random Access Memory (RAM), an Electrically-Erasable Programmable Read-Only Memory (EEPROM), a storage drive, an optical disc, and/or other suitable memory. Memory 704 may also include a random access non-volatile memory that can retain content when the power is off.

Memory 704 stores instructions to be executed by processor 702 including instructions for priority determiner 714, reliability determiner 716, path determiner 718, utilization determiner 720 and best time slot determiner 722. The components of system 700 may be implemented in the form of executable instructions stored on at least memory 704 and executed by at least one processor of system 700. Memory 704 may be non- transitory. Each of the components of system 700 may be implemented in the form of at least one hardware device including electronic circuitry for implementing the functionality of the component.

Processor 702 may execute instructions of priority determiner 714 to determine a priority for each element in a plurality of elements connected to a network. The plurality of elements may include a source element, a destination element and a first element selected for downtime. Priority determiner 714 may also determine an application priority for each application in a plurality of applications served by the network and determine the priority for each element based on the priority of the applications served by the respective element. The priority of an element may be equivalent to a highest priority of an application served by the first element. Processor 702 may execute instructions of reliability determiner 716 to a reliability index for each element in the plurality of elements.

Processor 702 may execute instructions of path determiner 718 to determine a plurality of paths between the source element and destination element. Each path may include a corresponding plurality of elements excluding the first element. Path identifier 718 may determine that a new path that is possible based on the topology of the network but is not currently configured and include the new path in the plurality of paths. Path determiner 718 may also identify an existing path between the source element and the destination element, the existing path including the first element.

Processor 702 may execute instructions of utilization determiner 720 to determine, for each path in the plurality, a total utilization of the corresponding plurality of elements of the path over a time period. Processor 702 may execute instructions of best time slot determiner 722 to determine a best time slot during the time period to be used for downtime of the first element. In some aspects, system 700 may also include a parameter receiver (not pictured) to receive a set of tunable parameters including at least one of an acceptable reliability index, an acceptable deviation for the acceptable reliability index, the time period and an analysis period. Best time slot determiner 722 may determine the best time slot based on the acceptable reliability index of a path belonging to the plurality of paths and the number of elements in the path.

Best time slot determiner 722 may determine a first element and a second element of the corresponding plurality of elements of each path for each of the plurality of time slots and perform a peak of sum analysis on a first utilization of the first element and a second utilization of the second element with respect to an available resource of the network. Best time slot determiner 722 may void a time slot corresponding to a path from the plurality of paths when a total utilization for elements in the path exceeds the available resource of the network during the time slot. Best time slot determiner 722 may determine for each element in each path, whether the reliability index of the element meets the acceptable reliability index and may void a time slot corresponding to a path from the plurality of paths if any element in the path does not meet the acceptable reliability index during the time slot.

FIG. 8 is a block diagram of an example system 800 for time slot determination. In the example illustrated in FIG. 8, system 800 includes a processor 802 and a machine-readable storage medium 804. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 802 may be at least one central processing unit (CPU), microprocessor, and/or other hardware devices suitable for retrieval and execution of instructions stored in machine-readable storage medium 804. In the example illustrated in FIG. 8, processor 802 may fetch, decode, and execute instructions 806, 808, 810, 812 and 814 to perform time slot determination. Processor 802 may include at least one electronic circuit comprising a number of electronic components for performing the functionality of at least one of the instructions in machine-readable storage medium 804. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 804 may be any electronic, magnetic, optical, or other physical storage device that stores executable instructions. Thus, machine-readable storage medium 804 may be, for example, Random Access Memory (RAM), an Electrically-Erasable Programmable Read-Only Memory (EEPROM), a storage drive, an optical disc, and the like. Machine-readable storage medium 504 may be disposed within system 800, as shown in FIG. 8. In this situation, the executable instructions may be “installed” on the system 800. Machine-readable storage medium 804 may be a portable, external or remote storage medium, for example, that allows system 800 to download the instructions from the portable/external/remote storage medium. In this situation, the executable instructions may be part of an “installation package”. As described herein, machine-readable storage medium 804 may be encoded with executable instructions for context aware data backup.

The machine-readable storage medium may be non-transitory. Referring to FIG. 8, priority determine instructions 806, when executed by a processor (e.g., 802), may cause system 800 to determine a priority for each element in a plurality of elements connected to a storage area network, wherein the plurality of elements includes a source element, a destination element and a downtime element. Priority determine instructions 806, when executed by a processor (e.g., 802), may also cause system 800 to determine an application priority for each application in a plurality of applications served by the network; and determine the priority for each element based on the priority of the applications served by the respective element. The priority of an element may be equivalent to a highest priority of an application served by that element.

Reliability determine instructions 808, when executed by a processor (e.g., 802), may cause system 800 to determine a reliability index for each element in the plurality of elements. Path determine instructions 810, when executed by a processor (e.g., 802), may cause system 800 to determine a plurality of paths between the source element and destination element. Each path may include a corresponding plurality of elements that does not include the downtime element. Path determine instructions 810, when executed by a processor (e.g., 802), may cause system 800 to identify an existing path between the source element and the destination element, the existing path including the downtime element. Path determine instructions 810, when executed by a processor (e.g., 802), may also cause system 800 to determine a new path that is possible based on the topology of the network but is not currently configured and include the new path in the plurality of paths.

Reliability determine instructions 812, when executed by a processor (e.g., 802), may cause system 800 to determine, for each path in the plurality of paths, a total utilization of the corresponding plurality of elements for a plurality of time slots in a time period. For example, reliability determine instructions 812, when executed by a processor (e.g., 802), may cause system 800 to determine a first element and a second element of the corresponding plurality of elements of each path in the plurality of paths, perform a peak of sum analysis on a first utilization of the first element and a second utilization of the second element with respect to an available bandwidth of the storage area network and void a first time slot corresponding to a first path if the total utilization of elements in the first exceeds the available bandwidth of the network during the first time slot. Reliability determine instructions 812, when executed by a processor (e.g., 802), may also cause system 800 to determine for each element in each path, whether the reliability index of the element meets the acceptable reliability index during the plurality of time slots void a first time slot corresponding to a first path from the plurality of paths if any element in the first path does not meet the acceptable reliability index during the first time slot.

Time slot determine instructions 814, when executed by a processor (e.g., 802), may cause system 800 to determine, from the plurality of paths, a best time slot to be used for downtime of the downtime element. Time slot determine instructions 814, when executed by a processor (e.g., 802), may cause system 800 to determine the best time slots based on the total utilization of each path, a reliability index of each path and the number of elements in each path.

The foregoing disclosure describes a number of examples for time slot determination. The disclosed examples may include systems, devices, computer-readable storage media, and methods for time slot determination. For purposes of explanation, certain examples are described with reference to the components illustrated in FIGS. 1-8. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-8 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising:
determining, by a processor, a priority for each element in a plurality of elements connected to a network, wherein the plurality of elements includes a source element, a destination element and a first element selected for downtime;
determining, by the processor, a reliability index for each element in the plurality of elements;
determining, by the processor, a plurality of alternate paths between the source element and destination element, each alternate path including a corresponding plurality of elements;
determining, by the processor, for each alternate path in the plurality, a total utilization of the corresponding plurality of elements of the alternate path for each of a plurality of time slots; and
determining, by the processor, based on the total utilizations, a best time slot to be used as a time period for the downtime of the first element.

2. The method of claim 1 comprising:
identifying, by the processor, an existing path between the source element and the destination element, the existing path including the downtime element.

3. The method of claim 1 comprising:
determining, by the processor, an application priority for each application in a plurality of applications served by the network; and
determining, by the processor, the priority for each element based on the priority of the applications served by the respective element.

4. The method of claim 3 wherein the priority of a first element is equivalent to a highest priority of an application served by the first element.

5. The method of claim 1 comprising:
receiving, by the processor, a set of tunable parameters including an acceptable reliability index, an acceptable deviation for the acceptable reliability index, the time period or an analysis period.

6. The method of claim 5 comprising:
determining, by the processor, the best time slot using the acceptable reliability index of the alternate path and the number of elements in the alternate path.

7. The method of claim 1 comprising:
determining, by the processor, a new path that is possible based on the topology of the network but is not currently configured; and
including the new path in the plurality of alternate paths.

8. The method of claim 1, wherein determining the total utilization comprises:
determining, by the processor, a first element and a second element of the corresponding plurality of elements of each alternate path for each of the plurality of time slots; and
performing, by the processor, a peak of sum analysis on a first utilization of the first element and a second utilization of the second element with respect to an available resource of the network.

9. The method of claim 8 comprising:
voiding, by the processor, a first time slot corresponding to a first alternate path from the plurality of alternate paths when a first total utilization for elements in the first alternate path exceeds the available resource of the network during the first time slot.

10. The method of claim 8 comprising:
receiving, by the processor, an acceptable reliability index;
determining, by the processor, for each element in each alternate path, whether the reliability index of the element meets the acceptable reliability index; and
voiding, by the processor, a first time slot corresponding to a first alternate path from the plurality of alternate paths if any element in the first alternate path does not meet the acceptable reliability index during the first time slot.

11. A system comprising:
a priority determiner to determine a priority for each element in a plurality of elements connected to a network, wherein the plurality of elements includes a source element, a destination element and a first element selected for downtime;
a reliability determiner to determine a reliability index for each element in the plurality of elements;
a path determiner to determine a plurality of paths between the source element and destination element, each path including a corresponding plurality of elements excluding the downtime element;
a utilization determiner to determine, for each path in the plurality, a total utilization of the corresponding plurality of elements of the path over a time period; and
a best path determiner to determine a best time slot during the time period to be used for downtime of the first element.

12. The system of claim 11 comprising:
the priority determiner to:
determine an application priority for each application in a plurality of applications served by the network; and
determine the priority for each element based on the priority of the applications served by the respective element.

13. The system of claim 12 wherein the priority of a first element is equivalent to a highest priority of an application served by the first element.

14. The system of claim 11 comprising:
a parameter receiver to receive a set of tunable parameters including at least one of an acceptable reliability index, an acceptable deviation for the acceptable reliability index, the time period and an analysis period.

15. The system of claim 14 comprising:
the best path determiner to determine the best time slot based on the acceptable reliability index of a first path belonging to the plurality of paths and the number of elements in the first path.

16. A non-transitory machine-readable storage medium encoded with instructions, the instructions executable by a processor of a system to cause the system to:
determine a priority for each element in a plurality of elements connected to a storage area network, wherein the plurality of elements includes a source element, a destination element and a downtime element;
determine a reliability index for each element in the plurality of elements;
determine a plurality of paths between the source element and destination element, wherein each path includes a corresponding plurality of elements and does not include the downtime element;
determine, for each path in the plurality of paths, a total utilization of the corresponding plurality of elements for a plurality of time slots in a time period; and
determine, from the plurality of paths, a best time slot to be used for downtime of the downtime element.

17. The non-transitory machine-readable storage medium of claim 16, wherein the instructions executable by the processor of the system further cause the system to:
determine a first element and a second element of the corresponding plurality of elements of each path in the plurality of paths; and
perform a peak of sum analysis on a first utilization of the first element and a second utilization of the second element with respect to an available bandwidth of the storage area network.

18. The non-transitory machine-readable storage medium of claim 16, wherein the instructions executable by the processor of the system further cause the system to:
void a first time slot corresponding to a first path if the total utilization of elements in the first exceeds the available bandwidth of the network during the first time slot.

19. The non-transitory machine-readable storage medium of claim 16, wherein the instructions executable by the processor of the system further cause the system to:
receive an acceptable reliability index;
determine for each element in each path, whether the reliability index of the element meets the acceptable reliability index during the plurality of time slots; and
void a first time slot corresponding to a first path from the plurality of paths if any element in the first path does not meet the acceptable reliability index during the first time slot.

20. The non-transitory machine-readable storage medium of claim 16, wherein the instructions executable by the processor of the system further cause the system to:
determine the best time slot based on the total utilization of each path, a reliability index of each path and the number of elements in each path.
